(19) United States
(12) Patent Application Publication
(10) Pub. No.: US 2024/0361178 A1
(43) Pub. Date: Oct. 31, 2024

(54) MONITORING SYSTEM, MONITORING APPARATUS, AND MONITORING METHOD

(71) Applicant: NEC Corporation, Tokyo (JP)

(72) Inventors: Tadayuki IWANO, Tokyo (JP); Koyo Mori, Tokyo (JP)

(73) Assignee: NEC Corporation, Tokyo (JP)

(21) Appl. No.: 18/630,083

(22) Filed: Apr. 9, 2024

(30) Foreign Application Priority Data
Apr. 25, 2023 (JP) 2023-071342

(51) Int. Cl. G01H 9/00; G06Q 50/08

(52) U.S. Cl. CPC G01H 9/004; G06Q 50/08

(57) ABSTRACT

A monitoring system according to the present disclosure includes: an optical fiber; at least one memory configured to store instructions; and at least one processor configured to execute the instructions for transmitting pulsed light to the optical fiber and receiving an optical signal from the optical fiber, detecting, for each of a plurality of measurement points in the optical fiber, vibration intensity of vibration generated at the measurement point, based on the optical signal received from the optical fiber, and specifying a measurement point having vibration intensity equal to or higher than a predetermined threshold value from among the plurality of measurement points.

### INCORPORATION BY REFERENCE

This application is based upon and claims the benefit of priority from Japanese patent application No. 2023-071342, filed on Apr. 25, 2023, the disclosure of which is incorporated herein in its entirety by reference.

### TECHNICAL FIELD

The present disclosure relates to a monitoring system, a monitoring apparatus, and a monitoring method.

### BACKGROUND ART

Large vibration is generated during civil engineering works such as tunnel construction and road construction, and construction works of structures such as buildings.

Therefore, there may be a social problem that residents in the vicinity of a construction site are affected by vibration generated by a construction work, such as feeling of stress and anxiety, and deterioration in physical condition.

Therefore, it is important to carry out the construction work without generating excessive vibration, by periodically monitoring vibration in the vicinity of the construction site.

However, when the vibration in the vicinity of the construction site is monitored manually, it takes a great deal of cost and time for such monitoring. Therefore, there is an increasing demand for a technique for monitoring vibration generated in construction work without using manpower.

For example, Japanese Unexamined Patent Application Publication No. H05-180690 describes a technique for monitoring vibration generated in road construction. Specifically, in the technique described in Japanese Unexamined Patent Application Publication No. H05-180690, interference of light transferred through an optical fiber built in or arranged parallel to a power cable is observed. When road construction is performed in the vicinity of the power cable, vibration is generated according to the road construction, and a strain occurs in the optical fiber. Therefore, presence or absence of road construction may be detected by observing the interference of light.

As described above, the technique described in Japanese Unexamined Patent Application Publication No. H05-180690 is capable of detecting vibration generated in road construction.

However, the technique described in Japanese Unexamined Patent Application Publication No. H05-180690 is capable of merely detecting presence or absence of road construction, and therefore, there is a problem that it is impossible to perform a construction work in which an influence of vibration on neighboring residents is suppressed only by using a result of the detection.

### SUMMARY

Therefore, in view of the above-described problems, an example object of the present disclosure is to provide a monitoring system, a monitoring apparatus, and a monitoring method that are capable of suppressing an influence of vibration on neighboring residents.

In a first example aspect, a monitoring system includes:
an optical fiber;
a communication unit configured to transmit pulsed light to the optical fiber and receive an optical signal from the optical fiber;
a detection unit configured to detect, for each of a plurality of measurement points in the optical fiber, vibration intensity of vibration generated at the measurement point, based on the optical signal received from the optical fiber; and
a specification unit configured to specify a measurement point having vibration intensity equal to or higher than a predetermined threshold value from among the plurality of measurement points.

In a second example aspect, a monitoring apparatus includes:
a communication unit configured to transmit pulsed light to an optical fiber, and receive an optical signal from the optical fiber;
a detection unit configured to detect, for each of a plurality of measurement points in the optical fiber, vibration intensity of vibration generated at the measurement point, based on the optical signal received from the optical fiber; and
a specification unit configured to specify a measurement point having vibration intensity equal to or higher than a predetermined threshold value from among the plurality of measurement points.

In a third example aspect, a monitoring method is a monitoring method performed by a monitoring apparatus, the monitoring method including:
a communication step of transmitting pulsed light to an optical fiber, and receiving an optical signal from the optical fiber;
a detection step of detecting, for each of a plurality of measurement points in the optical fiber, vibration intensity of vibration generated at the measurement point, based on the optical signal received from the optical fiber; and
a specification step of specifying a measurement point having vibration intensity equal to or higher than a predetermined threshold value from among the plurality of measurement points.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating a configuration example of a monitoring system according to a first example embodiment;

FIG. 2 is a diagram illustrating an example of an association table held by a detection unit according to the first example embodiment;

FIG. 3 is a diagram illustrating an example of a detection result of vibration intensity for each of a plurality of measurement points, detected by the detection unit according to the first example embodiment;

FIG. 4 is a flowchart illustrating an example of a schematic operation flow of the monitoring system according to the first example embodiment;

FIG. 5 is a diagram illustrating a configuration example of a monitoring system according to a second example embodiment;

FIG. 6 is a diagram illustrating an example of a GUI screen displayed on a display unit by a display control unit according to the second example embodiment;

FIG. 7 is a flowchart illustrating an example of a schematic operation flow of the monitoring system according to the second example embodiment; and

FIG. 8 is a block diagram illustrating an example of a hardware configuration of a computer that achieves a monitoring apparatus according to the example embodiments.

### EXAMPLE EMBODIMENT

Hereinafter, example embodiments of the present disclosure is described with reference to the drawings. Note that the following description and the drawings are omitted and simplified as appropriate for clarity of description. In the following drawings, the same element is denoted by the same reference sign, and redundant descriptions are omitted as necessary. Further, specific numerical values and the like described below are merely examples for facilitating understanding of the present disclosure, and are not limited thereto. Further, in the following example embodiments, an optical fiber is described as being installed in the vicinity of a construction site, but the optical fiber is not limited to being installed in the periphery of the construction site, and an optical fiber installed in any place may be utilized.

### First Example Embodiment

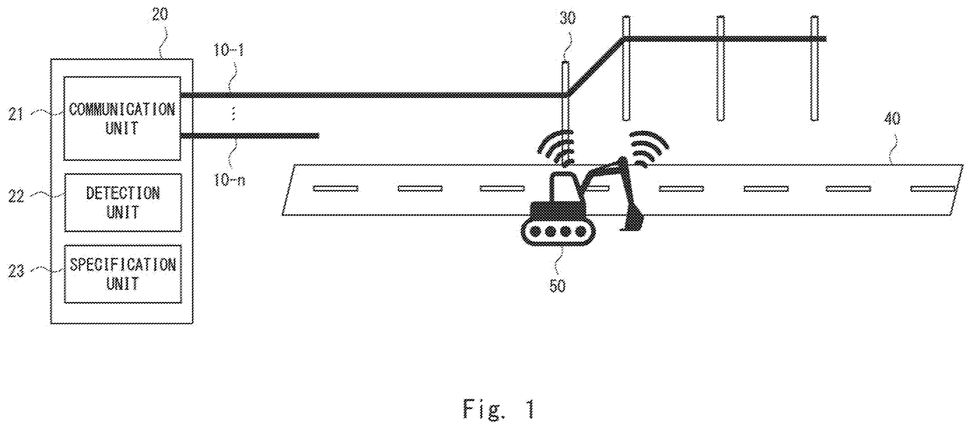

First, a configuration example of a monitoring system according to a first example embodiment is described with reference to FIG. 1. As illustrated in FIG. 1, the monitoring system according to the first example embodiment includes optical fibers 10-1 to 10-n (n is an integer of 2 or more) and a monitoring apparatus 20. Hereinafter, when an optical fiber is not specified among the optical fibers 10-1 to 10-n, such optical fiber is simply referred to as an “optical fiber 10” as appropriate.

The optical fiber 10 is installed in the vicinity of a construction site. The vicinity of the construction site is defined as, for example, within a predetermined distance range from the construction site, but is not limited thereto. Further, in FIG. 1, a construction vehicle 50 is illustrated on the assumption that the type of construction work performed in the vicinity of the optical fiber 10 is road construction. However, the type of construction work is not limited to road construction. For example, the type of construction work may be another civil engineering work such as tunnel construction, or may be a construction work of a structure such as a building.

A plurality of optical fibers 10 are provided. However, the number of the optical fibers 10 is not limited to a plural number, and may be one. That is, at least one optical fiber 10 may be provided.

Further, the optical fiber 10 is installed in an overhead manner on utility poles 30 along a road 40. However, the method of installing the optical fiber 10 is not limited to overhead installation. For example, the optical fiber 10 may be laid underground, such as under the road 40.

The monitoring apparatus 20 is achieved by, for example, a sensing apparatus such as a distributed fiber optic sensing (DFOS) apparatus, and includes a communication unit 21, a detection unit 22, and a specification unit 23.

The optical fiber 10 is connected to the communication unit 21.

In a case where a single optical fiber 10 is being connected thereto, the communication unit 21 transmits pulsed light to such optical fiber 10, and receives, as an optical signal, backscattered light which is generated when the pulsed light is being transferred through the optical fiber 10.

In addition, in a case where a plurality of optical fibers 10 are being connected thereto, the communication unit 21 transmits pulsed light to each of the plurality of optical fibers 10, and receives, as an optical signal, backscattered light which is generated when the pulsed light is being transferred through each of the plurality of optical fibers 10.

When vibration is generated at a certain point in the optical fiber 10, the optical signal being transferred through the optical fiber 10 changes in characteristics (e.g., wavelength).

Therefore, the detection unit 22 is able to detect the vibration generated at the certain point in the optical fiber 10, based on the optical signal received from the optical fiber 10 by the communication unit 21, and is further able to detect vibration intensity of the detected vibration.

Further, the detection unit 22 is able to specify, based on a time difference between a time point when the pulsed light is transmitted to the optical fiber 10 by the communication unit 21, and a time point when the optical signal is received from the optical fiber 10 by the communication unit 21, a position where the optical signal is generated, that is, a position where the vibration detected based on the optical signal is generated (distance of the optical fiber 10 from the monitoring apparatus 20).

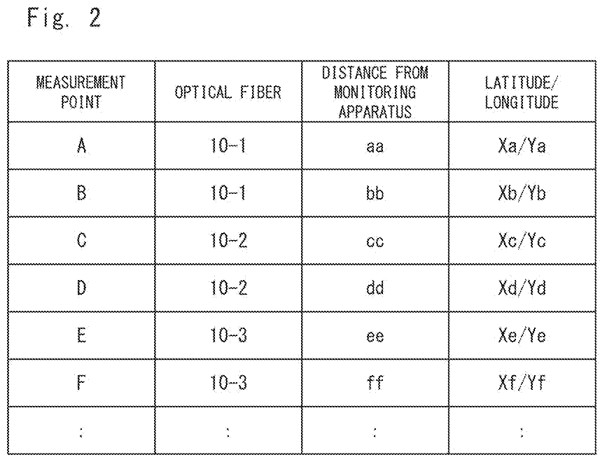

In the first example embodiment, a plurality of measurement points are set on the optical fiber 10. The detection unit 22 holds an association table indicating, for each of the plurality of measurement points, an optical fiber 10 in which the measurement point is set, the distance of the measurement point from the monitoring apparatus 20, and the latitude/longitude of the measurement point. An example of the association table is illustrated in FIG. 2. Note that the association table is not limited to being held by the detection unit 22. For example, any constituent element inside or outside the monitoring apparatus 20 may hold the association table, and the detection unit 22 may read and use the association table.

Further, the detection unit 22 is able to detect vibration intensity of the vibration generated at the measurement point for each of the plurality of measurement points, by using an association table as illustrated in FIG. 2. For example, in the example of FIG. 2, the detection unit 22 detects vibration intensity of vibration generated at a position which is at a distance aa from the monitoring apparatus 20, among the positions on the optical fiber 10-1, as vibration intensity of vibration generated at a measurement point A (latitude/longitude: Xa/Ya).

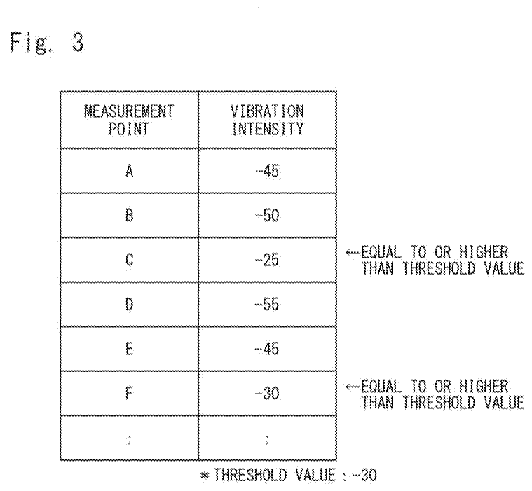

The specification unit 23 specifies a measurement point having vibration intensity equal to or higher than a predetermined threshold value, based on the detection result of vibration intensity for each of the plurality of measurement points detected by the detection unit 22. FIG. 3 illustrates an example of the detection result of vibration intensity for each of the plurality of measurement points. In the example of FIG. 3, the threshold value is “−30”, and measurement points having vibration intensity equal to or higher than the threshold value are two measurement points C and F. Therefore, the specification unit 23 specifies the measurement points C and F as the measurement points having vibration intensity equal to or higher than the threshold value.

Note that, in the first example embodiment, the communication unit 21, the detection unit 22, and the specification unit 23 are provided in the same monitoring apparatus 20, but the present disclosure is not limited thereto, and such units may be arranged separately from one another. For example, the communication unit 21, the detection unit 22, and the specification unit 23 may be arranged in separate apparatuses. Further, the detection unit 22 and the specification unit 23 may be arranged on the cloud.

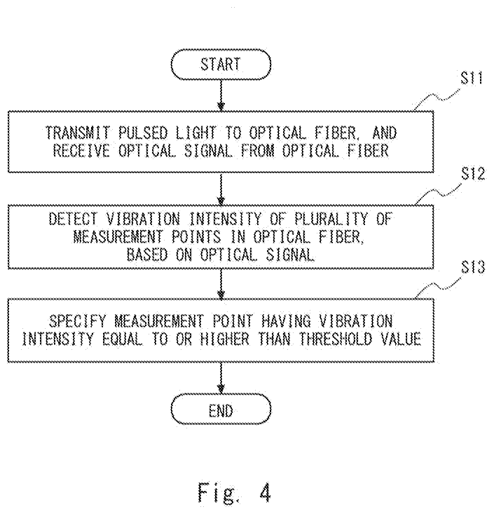

Next, an example of a schematic operation flow of the monitoring system according to the first example embodiment is described with reference to FIG. 4.

As illustrated in FIG. 4, the communication unit 21 transmits pulsed light to the optical fiber 10 and receives, as an optical signal, backscattered light from the optical fiber 10 (step S11).

Next, the detection unit 22 detects, for each of a plurality of measurement points, vibration intensity of vibration generated at each measurement point, based on the optical signal received by the communication unit 21 in step S11 (step S12).

Thereafter, the specification unit 23 specifies a measurement point having vibration intensity equal to or higher than a predetermined threshold value, based on a detection result of vibration intensity for each of the plurality of measurement points detected by the detection unit 22 in step S12 (step S13). As described above, according to the first example embodiment, the communication unit 21 transmits a pulsed light to the optical fiber 10 and receives an optical signal from the optical fiber 10. The detection unit 22 detects, for each of a plurality of measurement points, vibration intensity of vibration generated at each measurement point, based on the optical signal. The specification unit 23 specifies a measurement point having vibration intensity equal to or higher than a predetermined threshold value from among the plurality of measurement points.

Therefore, it is possible to specify a measurement point having vibration intensity equal to or higher than a threshold value, that is, a measurement point where a large vibration is generated, from among the measurement points in the vicinity of the construction site. Thus, for example, it is possible to perform a construction work in which the influence of vibration on a specified measurement point is suppressed, to thereby suppress the occurrence of social problems caused by the vibration, and a construction work which is safe and worry-free for the neighboring residents may be performed. Therefore, in the first example embodiment, it is possible to suppress the influence of vibration on the neighboring residents.

### Second Example Embodiment

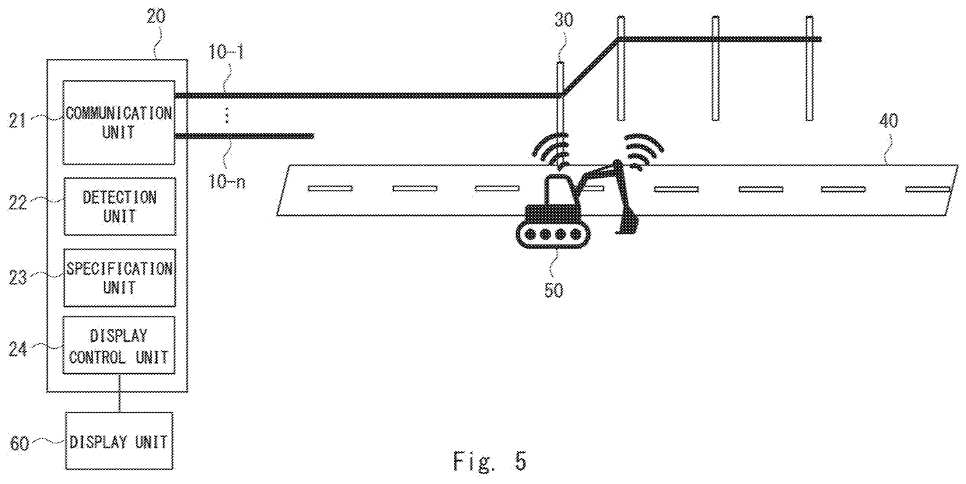

Next, a configuration example of a monitoring system according to a second example embodiment is described with reference to FIG. 5. As illustrated in FIG. 5, the monitoring system according to the second example embodiment differs from the configuration illustrated in FIG. 1 of the above-described first example embodiment in that a display unit 60 is added and that a display control unit 24 is added inside the monitoring apparatus 20.

The display unit 60 is achieved by a display, a monitor, or the like. In FIG. 5, the display unit 60 is provided outside the monitoring apparatus 20, but the present disclosure is not limited thereto, and may be provided inside the monitoring apparatus 20.

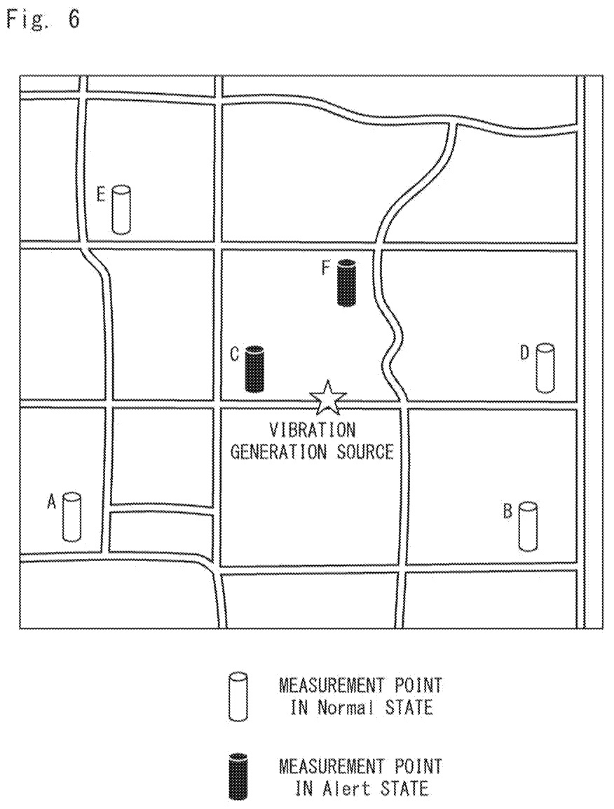

The display control unit 24 causes the display unit 60 to display various graphical user interface (GUI) screens. In the second example embodiment, the display control unit 24 causes the display unit 60 to display positions of a plurality of measurement points superimposed on a map, and simultaneously causes the display unit 60 to display the measurement points specified by the specification unit 23 in such a way as to be differentiated from other measurement points. Further, the display control unit 24 may cause the display unit 60 to display a position of a vibration generation source in the construction site (for example, in the case of road construction, the vibration generation source is the construction vehicle 50 in FIG. 1) superimposed on the map. FIG. 6 illustrates an example of a GUI screen to be displayed by the display unit 60, in a case where the detection result of vibration intensity for each of the plurality of measurement points is the result illustrated in FIG. 3. In the example of FIG. 3, among measurement points A to F, measurement points having vibration intensity equal to or higher than the threshold value are measurement points C and F. Therefore, in the example of FIG. 6, the positions of the measurement points A to F are displayed by being superimposed on the map, and the measurement points C and F are displayed in solid color in such a way as to be differentiated from the other measurement points A, B, D, and E. Optionally, the position of the vibration generating source is also displayed by being superimposed on the map.

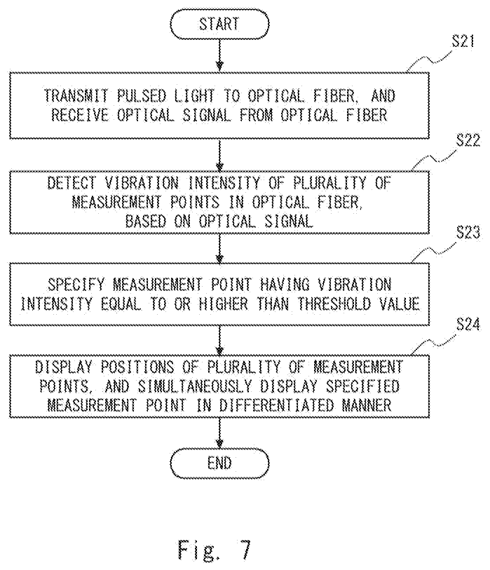

Next, an example of a schematic operation flow of the monitoring system according to the second example embodiment is described with reference to FIG. 7.

As illustrated in FIG. 7, first, processing of steps S21 to S23 similar to steps S11 to S13 of FIG. 4 of the first example embodiment described above are performed.

Thereafter, the display control unit 24 causes the display unit 60 to display the positions of the plurality of measurement points superimposed on the map, and simultaneously causes the display unit 60 to display the measurement points specified by the specification unit 23 in step S23 in such a way as to be differentiated from other measurement points (step S24).

As described above, according to the second example embodiment, the display control unit 24 causes the display unit 60 to display the positions of the plurality of measurement points superimposed on the map, and simultaneously causes the display unit 60 to display the measurement points specified as having vibration intensity equal to or higher than the predetermined threshold value in such a way as to be differentiated from other measurement points. As a result, it is possible to visually recognize the positions of the plurality of measurement points in the vicinity of the construction site, and further, it is possible to visually recognize a measurement point having vibration intensity equal to or higher than a threshold value, that is, a measurement point in which a large vibration is being generated.

Other effects are the same as those of the first example embodiment described above.

### Other Example Embodiments

In the first and second example embodiments described above, one communication unit 21 and one detection unit 22 are provided, but the present disclosure is not limited thereto. For example, in a case where a plurality of optical fibers 10 are being provided, a plurality of communication units 21 and a plurality of detection units 22 may be provided in association with the plurality of optical fibers 10. In such a case, the communication unit 21 may be connected only to an associated optical fiber 10, may transmit pulsed light to the associated optical fiber 10, and may receive an optical signal from the associated optical fiber 10. Further, the detection unit 22 may detect vibration intensity of vibration generated at a measurement point set on an associated optical fiber 10, based on the optical signal received from the associated optical fiber 10 by an associated communication unit 21.

Further, in the second example embodiment described above, the display control unit 24 causes a measurement point specified as having vibration intensity equal to or higher than the predetermined threshold value to be displayed in solid color, in such a way as to be differentiated from other measurement points, but the present disclosure is not limited thereto. For example, the display control unit 24 may change the color or the shape of a mark of the specified measurement point.

In the second example embodiment described above, the display control unit 24 causes only the measurement points set on the optical fiber 10 to be displayed, but the present disclosure is not limited thereto. For example, the display control unit 24 may cause a position of an additional measurement point, which is not on the optical fiber 10 and vibration intensity of which is detected by a vibration sensor other than the optical fiber 10, to be displayed by being superimposed on the map. The number of additional measurement points may be at least one. In such a case, the specification unit 23 may specify, among the at least one additional measurement point, an additional measurement point having vibration intensity equal to or higher than a predetermined threshold value. Further, the display control unit 24 may cause the specified additional measurement points to be displayed in such a way as to be differentiated from other measurement points and other additional measurement points.

Further, in the second example embodiment described above, the display control unit 24 causes only the position of the vibration generation source in the construction site to be displayed, but the present disclosure is not limited thereto. For example, the display control unit 24 may cause operation information indicating whether or not the vibration generation source is in operation to be displayed. The operation information may be displayed at the position of the vibration generation source on the map, or may be displayed outside the frame of the map.

In addition, the vibration detected at the measurement point in the above-described first and second example embodiments includes vibration caused by other factors (for example, vibration caused by traveling of a vehicle on the road 40) in addition to vibration caused by the vibration generation source at the construction site. Therefore, only vibration intensity of the vibration caused by the vibration generation source generated at the measurement point may be detected in the following manner. That is, the detection unit 22 may learn in advance the feature of the vibration caused by the vibration generation source. Then, the detection unit 22 may extract, for each of the plurality of measurement points, vibration having the learned feature from among the vibration generated at the measurement point, and detect vibration intensity of the extracted vibration. As a result, it is possible to specify, from among the measurement points in the vicinity of the construction site, a measurement point where a large vibration due to the vibration generation source in the construction site is being generated, rather than a measurement point where a large vibration is simply generated.

Herein, the vibration generating source in the construction site generates vibration having a frequency that is unique to the vibration generating source. Therefore, the feature of the vibration caused by the vibration generation source may be a frequency. In such a case, the detection unit 22 may learn in advance the frequency of the vibration caused by the vibration generation source. Then, the detection unit 22 may extract, for each of the plurality of measurement points, vibration having a learned frequency from among the vibration generated at the measurement point, and detect vibration intensity of the extracted vibration.

### Hardware Configuration of Monitoring Apparatus According to Example Embodiments

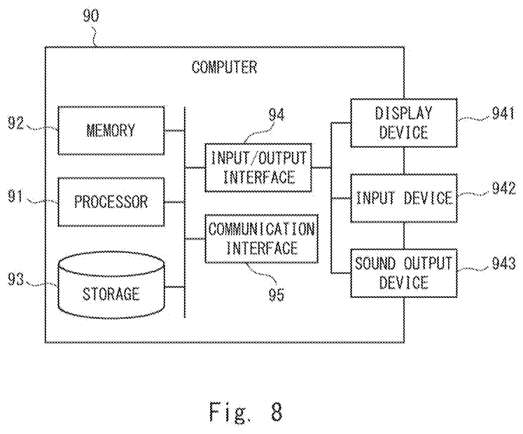

Next, a hardware configuration example of a computer 90 that achieves the monitoring apparatus 20 according to the first and second example embodiments described above is described with reference to FIG. 8.

As illustrated in FIG. 8, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for transmitting and receiving data to and from one another.

The processor 91 is, for example, an arithmetic processing unit such as a central processing unit (CPU) or a graphics processing unit (GPU). The memory 92 is, for example, a memory such as a random access memory (RAM) or a read only memory (ROM). The storage 93 is, for example, a storage device such as a hard disk drive (HDD), a solid state drive (SSD), or a memory card. Further, the storage 93 may be a memory such as a RAM or a ROM.

The storage 93 stores programs for implementing the functions of the constituent elements included in the monitoring apparatus 20. The processor 91 implements the functions of the constituent elements included in the monitoring apparatus 20 by executing the programs. Herein, when executing the programs, the processor 91 may read and execute the programs from the memory 92, or may execute the programs without reading from the memory 92. Further, the memory 92 and the storage 93 also serve to store information and data held by the constituent elements included in the monitoring apparatus 20.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

The input/output interface 94 is connected to a display device 941, an input device 942, a sound output device 943, and the like. The display device 941 is a device that displays a screen associated with drawing data processed by the processor 91, such as a liquid crystal display (LCD), a cathode ray tube (CRT) display, or a monitor. The input device 942 is a device that receives an operation input from an operator, and is, for example, a keyboard, a mouse, a touch sensor, or the like. The display device 941 and the input device 942 may be integrated and implemented as a touch panel. The sound output device 943 is a device, such as a speaker, that acoustically outputs a sound associated with sound data processed by the processor 91.

The communication interface 95 transmits and receives data to and from an external device. For example, the communication interface 95 communicates with the external device via a wired communication path or a wireless communication path.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure.

The first and second example embodiments may be combined as desirable by one of ordinary skill in the art.

The whole or part of the example embodiments disclosed above can be described as, but not limited to, the following supplementary notes.

### (Supplementary Note 1)

A monitoring system including:
an optical fiber;
a communication unit configured to transmit pulsed light to the optical fiber and receive an optical signal from the optical fiber;
a detection unit configured to detect, for each of a plurality of measurement points in the optical fiber, vibration intensity of vibration generated at the measurement point, based on the optical signal received from the optical fiber; and
a specification unit configured to specify a measurement point having vibration intensity equal to or higher than a predetermined threshold value from among the plurality of measurement points.

### (Supplementary Note 2)

The monitoring system according to supplementary note 1, further including a display control unit configured to cause a display unit to display positions of the plurality of measurement points superimposed on a map and simultaneously cause the display unit to display the specified measurement point in such a way as to be differentiated from other measurement points.

### (Supplementary Note 3)

The monitoring system according to supplementary note 2, wherein the display control unit causes the display unit to display a position of a vibration generation source being superimposed on a map.

### (Supplementary Note 4)

The monitoring system according to supplementary note 3, wherein the display control unit causes the display unit to display operation information indicating whether or not the vibration generation source is in operation.

### (Supplementary Note 5)

The monitoring system according to supplementary note 3, wherein the detection unit learns in advance a feature value of vibration being generated due to the vibration generation source, and extracts, for each of the plurality of measurement points, vibration having the learned feature value from among vibration generated at the measurement point, and detects vibration intensity of the extracted vibration.

### (Supplementary Note 6)

The monitoring system according to supplementary note 2, wherein the specification unit specifies, from among at least one additional measurement point which is not on the optical fiber and vibration intensity of which is detected by a vibration sensor other than the optical fiber, an additional measurement point having vibration intensity equal to or higher than a predetermined threshold value, and the display control unit causes the display unit to display a position of the at least one additional measurement point being superimposed on a map, and simultaneously causes the display unit to display the specified additional measurement point in such a way as to be differentiated from other measurement points and other additional measurement points.

### (Supplementary Note 7)

A monitoring apparatus including:
a communication unit configured to transmit pulsed light to an optical fiber, and receive an optical signal from the optical fiber;
a detection unit configured to detect, for each of a plurality of measurement points in the optical fiber, vibration intensity of vibration generated at the measurement point, based on the optical signal received from the optical fiber; and a specification unit configured to specify a measurement point having vibration intensity equal to or higher than a predetermined threshold value from among the plurality of measurement points.

### (Supplementary Note 8)

The monitoring apparatus according to supplementary note 7, further including a display control unit configured to cause a display unit to display positions of the plurality of measurement points being superimposed on a map, and simultaneously cause the display unit to display the specified measurement point in such a way as to be differentiated from other measurement points.

### (Supplementary Note 9)

The monitoring apparatus according to supplementary note 8, wherein the display control unit causes the display unit to display a position of a vibration generation source being superimposed on a map.

### (Supplementary Note 10)

The monitoring apparatus according to supplementary note 9, wherein the display control unit causes the display unit to display operation information indicating whether or not the vibration generation source is in operation.

### (Supplementary Note 11)

The monitoring apparatus according to supplementary note 9, wherein the detection unit
learns in advance a feature value of vibration being generated due to the vibration generation source, and
extracts, for each of the plurality of measurement points, vibration having the learned feature value from among vibration generated at the measurement point, and detects vibration intensity of the extracted vibration.

### (Supplementary Note 12)

The monitoring apparatus according to supplementary note 8, wherein
the specification unit specifies, from among at least one additional measurement point which is not on the optical fiber and vibration intensity of which is detected by a vibration sensor other than the optical fiber, an additional measurement point having vibration intensity equal to or higher than a predetermined threshold value, and
the display control unit causes the display unit to display a position of the at least one additional measurement point being superimposed on a map, and simultaneously causes the display unit to display the specified additional measurement point in such a way as to be differentiated from other measurement points and other additional measurement points.

### (Supplementary Note 13)

A monitoring method being performed by a monitoring apparatus, the monitoring method including:
a communication step of transmitting pulsed light to an optical fiber, and receiving an optical signal from the optical fiber;
a detection step of detecting, for each of a plurality of measurement points in the optical fiber, vibration intensity of vibration generated at the measurement point, based on the optical signal received from the optical fiber; and
a specification step of specifying a measurement point having vibration intensity equal to or higher than a predetermined threshold value from among the plurality of measurement points.

### (Supplementary Note 14)

The monitoring method according to supplementary note 13, further including a display control step of causing a display unit to display positions of the plurality of measurement points being superimposed on a map and simultaneously causing the display unit to display the specified measurement point in such a way as to be differentiated from other measurement points.

### (Supplementary Note 15)

The monitoring method according to supplementary note 14, wherein the display control step includes causing the display unit to display a position of a vibration generation source being superimposed on a map.

### (Supplementary Note 16)

The monitoring method according to supplementary note 15, wherein the display control step includes causing the display unit to display operation information indicating whether or not the vibration generation source is in operation.

### (Supplementary Note 17)

The monitoring method according to supplementary note 15, further including a learning step of learning in advance a feature value of vibration being generated due to the vibration generation source,
wherein the detection step includes extracting, for each of the plurality of measurement points, vibration having the learned feature value from among vibration generated at the measurement point, and detecting vibration intensity of the extracted vibration.

### (Supplementary Note 18)

The monitoring method according to supplementary note 14, wherein the specification step includes specifying, from among at least one additional measurement point which is not on the optical fiber and vibration intensity of which is detected by a vibration sensor other than the optical fiber, an additional measurement point having vibration intensity equal to or higher than a predetermined threshold value, and
the display control step includes causing the display unit to display a position of the at least one additional measurement point being superimposed on a map, and simultaneously causing the display unit to display the specified additional measurement point in such a way as to be differentiated from other measurement points and other additional measurement points.

What is claimed is:

1. A monitoring system comprising:
an optical fiber;
at least one memory configured to store instructions; and
at least one processor configured to execute the instructions for
transmitting pulsed light to the optical fiber, and receiving an optical signal from the optical fiber,
detecting, for each of a plurality of measurement points in the optical fiber, vibration intensity of vibration generated at the measurement point, based on the optical signal received from the optical fiber, and
specifying a measurement point having vibration intensity equal to or higher than a predetermined threshold value from among the plurality of measurement points.

2. The monitoring system according to claim 1, wherein the at least one processor is configured to further execute the instructions for causing a display unit to display positions of the plurality of measurement points superimposed on a map and simultaneously causing the display unit to display the specified measurement point in such a way as to be differentiated from other measurement points.

3. The monitoring system according to claim 2, wherein the at least one processor is configured to further execute the instructions for causing the display unit to display a position of a vibration generation source being superimposed on a map.

4. The monitoring system according to claim 3, wherein the at least one processor is configured to further execute the instructions for causing the display unit to display operation information indicating whether or not the vibration generation source is in operation.

5. The monitoring system according to claim 3, wherein the at least one processor is configured to further execute the instructions for
learning in advance a feature value of vibration being generated due to the vibration generation source, and
extracting, for each of the plurality of measurement points, vibration having the learned feature value from among vibration generated at the measurement point, and detecting vibration intensity of the extracted vibration.

6. The monitoring system according to claim 2, wherein the at least one processor is configured to further execute the instructions for
specifying, from among at least one additional measurement point which is not on the optical fiber and vibration intensity of which is detected by a vibration sensor other than the optical fiber, an additional measurement point having vibration intensity equal to or higher than a predetermined threshold value, and
causing the display unit to display a position of the at least one additional measurement point being superimposed on a map, and simultaneously causing the display unit to display the specified additional measurement point in such a way as to be differentiated from other measurement points and other additional measurement points.

7. A monitoring apparatus comprising:
at least one memory configured to store instructions; and
at least one processor configured to execute the instructions for
transmitting pulsed light to an optical fiber, and receiving an optical signal from the optical fiber,
detecting, for each of a plurality of measurement points in the optical fiber, vibration intensity of vibration generated at the measurement point, based on the optical signal received from the optical fiber, and
specifying a measurement point having vibration intensity equal to or higher than a predetermined threshold value from among the plurality of measurement points.

8. The monitoring apparatus according to claim 7, wherein the at least one processor is configured to further execute the instructions for causing a display unit to display positions of the plurality of measurement points being superimposed on a map and simultaneously causing the display unit to display the specified measurement point in such a way as to be differentiated from other measurement points.

9. The monitoring apparatus according to claim 8, wherein the at least one processor is configured to further execute the instructions for causing the display unit to display a position of a vibration generation source being superimposed on a map.

10. The monitoring apparatus according to claim 9, wherein the at least one processor is configured to further execute the instructions for causing the display unit to display operation information indicating whether or not the vibration generation source is in operation.

11. The monitoring apparatus according to claim 9, wherein the at least one processor is configured to further execute the instructions for
learning in advance a feature value of vibration being generated due to the vibration generation source, and
extracting, for each of the plurality of measurement points, vibration having the learned feature value from among vibration generated at the measurement point, and detecting vibration intensity of the extracted vibration.

12. The monitoring apparatus according to claim 8, wherein the at least one processor is configured to further execute the instructions for
specifying, from among at least one additional measurement point which is not on the optical fiber and vibration intensity of which is detected by a vibration sensor other than the optical fiber, an additional measurement point having vibration intensity equal to or higher than a predetermined threshold value, and
causing the display unit to display a position of the at least one additional measurement point being superimposed on a map, and simultaneously causing the display unit to display the specified additional measurement point in such a way as to be differentiated from other measurement points and other additional measurement points.

13. A monitoring method being performed by a monitoring apparatus, the monitoring method comprising:
a communication step of transmitting pulsed light to an optical fiber, and receiving an optical signal from the optical fiber;
a detection step of detecting, for each of a plurality of measurement points in the optical fiber, vibration intensity of vibration generated at the measurement point, based on the optical signal received from the optical fiber; and
a specification step of specifying a measurement point having vibration intensity equal to or higher than a predetermined threshold value from among the plurality of measurement points.

14. The monitoring method according to claim 13, further comprising a display control step of causing a display unit to display positions of the plurality of measurement points being superimposed on a map and simultaneously causing the display unit to display the specified measurement point in such a way as to be differentiated from other measurement points.

15. The monitoring method according to claim 14, wherein the display control step includes causing the display unit to display a position of a vibration generation source being superimposed on a map.

16. The monitoring method according to claim 15, wherein the display control step includes causing the display unit to display operation information indicating whether or not the vibration generation source is in operation.

17. The monitoring method according to claim 15, further comprising a learning step of learning in advance a feature value of vibration being generated due to the vibration generation source,
wherein the detection step includes extracting, for each of the plurality of measurement points, vibration having the learned feature value from among vibration generated at the measurement point, and detecting vibration intensity of the extracted vibration.

18. The monitoring method according to claim 14, wherein
the specification step includes specifying, from among at least one additional measurement point which is not on the optical fiber and vibration intensity of which is detected by a vibration sensor other than the optical fiber, an additional measurement point having vibration intensity equal to or higher than a predetermined threshold value, and
the display control step includes causing the display unit to display a position of the at least one additional measurement point being superimposed on a map, and simultaneously causing the display unit to display the specified additional measurement point in such a way as to be differentiated from other measurement points and other additional measurement points.
